(19) United States
(12) Patent Application Publication
(10) Pub. No.: US 2005/0189507 A1
(43) Pub. Date: Sep. 1, 2005

(54) Intercept valve for spray guns for water cleaner apparatus

(75) Inventor: Roberto Amaduzzi, Rubiera (Reggio Emilia) (IT)

Correspondence Address: YOUNG & THOMPSON, 745 SOUTH 23RD STREET, 2ND FLOOR, ARLINGTON, VA, 22202, US

(73) Assignee: ARROW LINE S.R.L., RUBIERA (REGGIO EMILIA) (IT)

(21) Appl. No.: 10/679,261

(22) Filed: Oct. 7, 2003

(30) Foreign Application Priority Data
Dec. 19, 2002 (IT) RE2002A000102

(51) Int. Cl. F16K 31/44

(52) U.S. Cl. 251/82

(57) ABSTRACT

The intercept valve comprises a main body exhibiting an internal cavity, a ball obturator arranged in the cavity, an annular seating having a longitudinal central axis, against which seating the ball obturator rests when the valve is closed, and a pusher element which exerts on the ball obturator a thrust which can detach the ball obturator from the annular seating. The pusher element is oriented in such a way that the thrust it exerts causes a displacement of the ball obturator in a direction which is transversal to the central axis of the annular seating.

### BACKGROUND OF THE INVENTION

The prior art teaches spray guns used in water cleaners including intercept valves which are opened and closed to allow or stop passage of liquid to the guns themselves. Generally the liquid is conveyed at a very high pressure, up to 350 bar.

The above-mentioned intercept valves comprise a main body exhibiting an internal cavity through which the liquid flows. The main body has an inlet, connected to a source of pressurised liquid, and an outlet connected to a tube from a front end of which a jet of the liquid issues at high pressure.

In the prior art, the terminal end of the tube upstream of the valve is inserted into the gun handle grip or arranged anteriorly thereof, forming a right-angle with the tube downstream, with which it combines to give rise to a fluid conveyor conduit.

In the internal cavity of the main body there is an obturator, which can have one of several different conformations, for example a ball or cone. In the valve closed position the obturator lies against an annular seating a central axis of which defines at that point the direction of the liquid flow crossing it. The obturator, whatever its conformation, is kept in contact with the annular seating by a thrust exerted by the pressurised fluid and, in the prior art, also by the action of a spring.

To bring the valve into the open position, the obturator is at least partially detached from the annular seating by a special mechanism which comprises manually-operated means for activating associated to the spray gun. In particular, in the case of a spherical obturator, a pusher element is included which exerts a push on the obturator which, in the prior art, is directed in the direction of the central longitudinal axis of the annular seating. The pusher element is generally constituted by a cylindrical pivot exhibiting a first end in contact with the spherical obturator and a second end emerging from the main body of the valve and destined to be pressed by the means for activating.

The force exerted by the pusher element to detach the obturator from the annular seating must overcome the whole hydraulic force which the liquid develops on the obturator in the flow direction, or in the direction of the longitudinal axis of the annular seating.

This is the force exerted by the hydrostatic pressure on the surface of the outlet mouth, which thus is of an especially high entity.

Furthermore, apart from the hydrostatic force, the force exerted by the pusher element must overcome the force of the spring, which is acting in the same direction as the hydrostatic force.

The prior art as briefly described above exhibits a number of drawbacks.

First and foremost, the force the pusher element must develop on the obturator to open the intercept valve is very high. Further, this force is not modifiable because it depends not only on the spring but also on the diameter of the hole in the annular seating, imposed by the passage section of the fluid and the pressure developed thereon.

Consequently, the activating mechanisms of the pusher element are strongly stressed and the situation becomes ever more critical as the fluid pressure increases.

Further, the arrangement of the pusher element in the direction of the longitudinal axis of the annular seating means that the inlet and outlet openings of the main body of the valve are not coaxial, so that there is, in the body of the valve, sufficient space for housing the pusher element. This necessitates making the valve body in complex shapes, leading to expensive production, in cases where the tube upstream is inserted into the gun handle grip, or positioning the inlet opening in an position which is anterior of the handle.

This last solution has the disadvantage of placing the tubing upstream of the valve and before the operator, which makes the gun more awkward to manoeuvre for the operator.

In any case, the non-coaxial arrangement between the inlet and outlet openings disturbs the liquid flow.

Also worth noting is the fact that the presence of a spring having direct contact on the ball obturator also causes an alteration in liquid flow.

The main technical aim of the present invention is to provide an intercept valve for spray guns for water cleaners in which the above-described drawbacks are obviated.

The main aim of the invention is to provide an intercept valve having a spherical obturator able considerably to reduce (with respect to the prior art and in comparable conditions of pressure and flow rate) a force necessary for displacing the obturator and bringing the valve into the open position.

A further important aim of the invention is to provide an intercept valve which, during the design phase, and with a simple modification of the size of the ball obturator, makes possible a change in the force necessary (in comparison with the prior art at the same pressure and flow rates) to displace the ball obturator into an open position.

A further aim of the invention is to provide an intercept valve having a spherical obturator in which the inlet and outlet openings can be coaxial, thus obtaining a simple conformation and in consequence a contained production cost of the valve as well as a high hydraulic performance.

A further aim of the invention is to provide an intercept valve which does not necessarily need an internal spring to return the ball obturator into the annular seating.

The technical aims are achieved by an intercept valve which is characterised in that it comprises one or more of the technical solutions described in the accompanying claims.

### SUMMARY OF THE INVENTION

The intercept valve comprises a main body exhibiting an internal cavity, a ball obturator arranged in the cavity, an annular seating having a longitudinal central axis, against which seating the ball obturator rests when the valve is closed, and a pusher element which exerts on the ball obturator a thrust which can detach the ball obturator from the annular seating. The pusher element is oriented in such a way that the thrust it exerts causes a displacement of the ball obturator in a direction which is transversal to the central axis of the annular seating.

### BRIEF DESCRIPTION OF THE DRAWINGS

A non-limiting example of the invention is now described, in a preferred but non-exclusive embodiment of the intercept valve of the invention, illustrating by way of example in the accompanying figures of the drawings, in which:

FIG. 1 is a lateral longitudinal section of a first embodiment of a spray gun in which the intercept valve of the invention is arranged posteriorly of the handle grip of the gun;

FIG. 2 is a lateral longitudinal section of a second embodiment of a spray gun in which the intercept valve of the invention is arranged anteriorly of the handle grip of the gun;

FIG. 3 is a longitudinal section of a third embodiment of a spray gun, similar to the gun of FIG. 1 but with different manual activating means;

FIG. 4 is a longitudinal section of the intercept valve of the invention in a closed position;

FIG. 5 is the section of FIG. 4 but with the intercept valve in the open position;

FIG. 6 schematically represents the forces acting on the ball obturator of the invention in the closed position;

FIG. 7 shows the forces acting on the obturator of FIG. 6 when the pusher element equipped on the valve for bringing the valve into the open position begins its intervention;

FIGS. 8 and 9 are similar to FIGS. 6 and 7, and show how the forces acting on the ball obturator change on increasing the diameter of the obturator.

### DESCRIPTION OF THE PREFERRED EMBODIMENTS

With reference to the figures, the intercept valve of the invention is indicated in its entirety by number 1.

The valve 1 comprises a main body 2 exhibiting an internal cavity 3 affording an inlet opening 4 and an outlet opening 5.

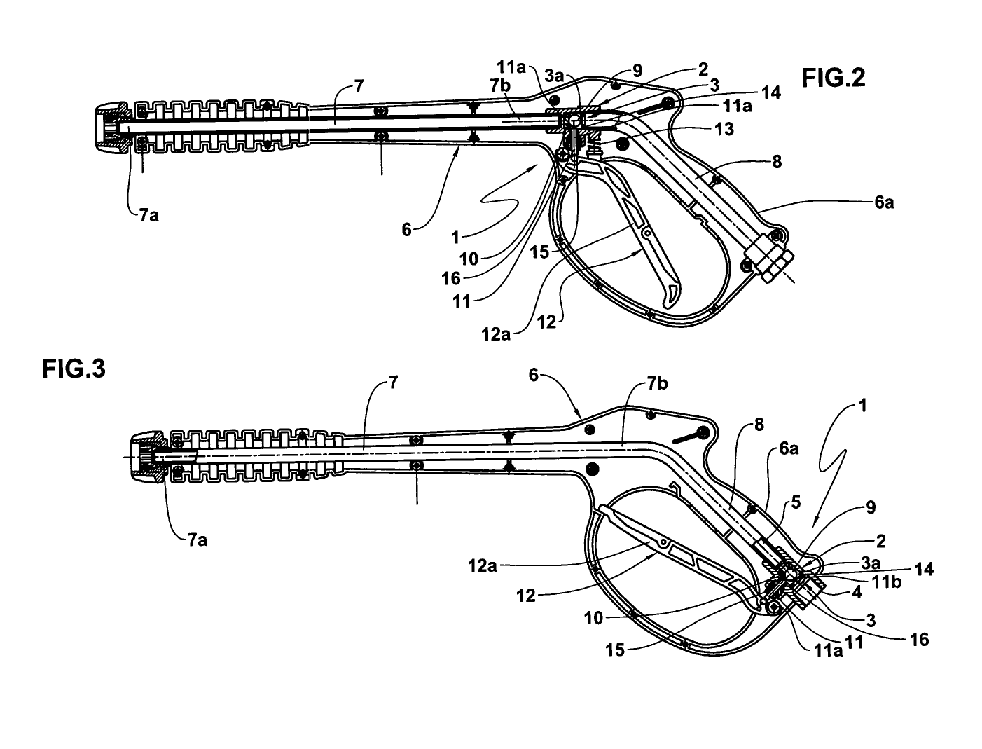

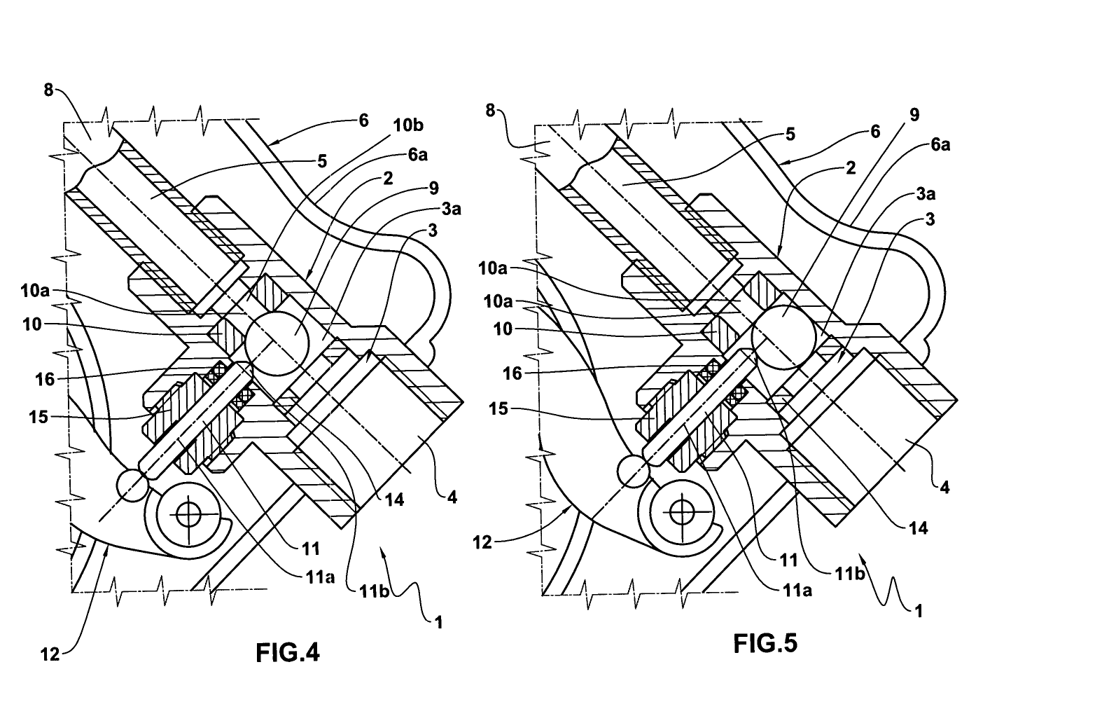

The intercept valve 1 is inserted in a spray gun 6, internally of which a tube 7 is housed, which tube 7 is arranged downstream of the valve 1 and comprises a first end 7a from which a jet of fluid issues and a second end 7b connected to the outlet opening 5. A supply tube 8 can be connected to the inlet opening 4; the supply tube 8 is located upstream of the valve 1 and is shown only in the embodiment of FIG. 2, where the end part is visible, inserted in a handle grip 6a of the gun 6.

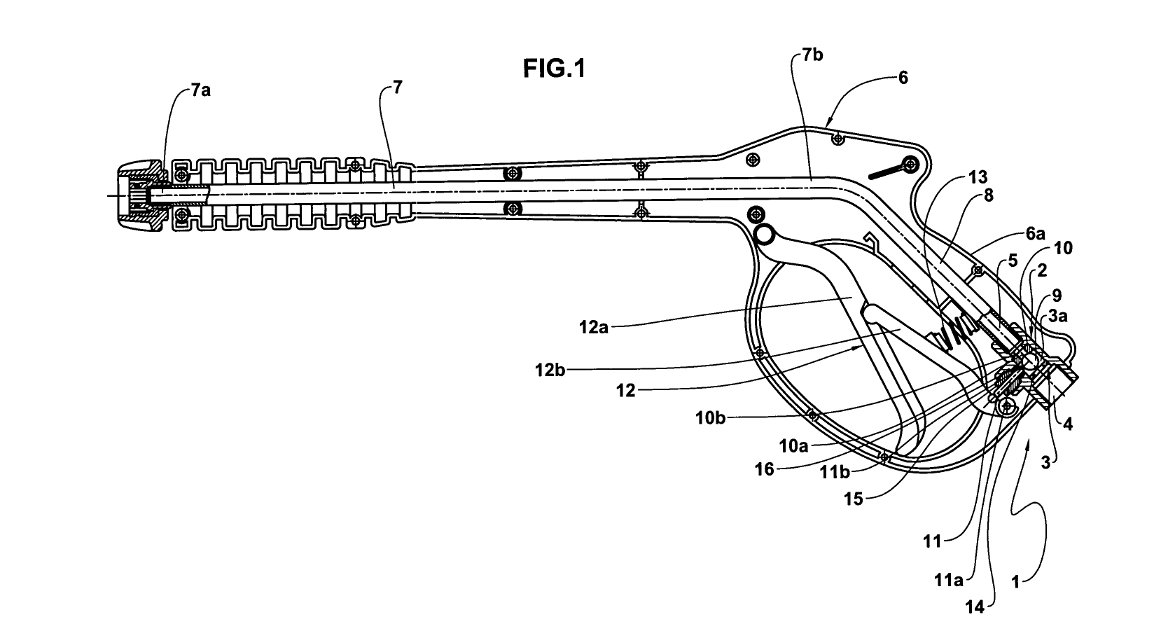

In the embodiments of FIGS. 1 and 3, the supply tube 8 is completely external of the gun 6 as the valve 1 is arranged posteriorly of the grip 6a of the gun 6. The downstream tube 6 and the upstream tube 8 together define a pressurised fluid conveyor conduit. This conduit is opened or closed for the passage or the arrest of the fluid from the intercept valve 1. In greater detail, internally of the cavity 3 is located an obturator 9, preferably spherical and preferably made of stainless steel. In the closed position of the valve 1, the ball obturator 9 rests against an annular seating 10, also made of stainless steel or plastic, and arranged in the cavity 3 of the main body 2 on the outlet opening 5 side.

The annular seating 10 exhibits a longitudinal axis 10a which defines the direction of the fluid flow crossing the passage hole 10b of the seating 10. The pusher element 11 commanded by manual means for activating 12 exerts a thrust on the ball obturator 9 which is sufficient to at least partially detach the obturator 9 from the annular seating 10, to bring the valve 1 into the open position. The means for actuating 12 of the first embodiment, illustrated in FIG. 1, comprise a pair of levers and, in particular, a command lever 12a and an activating lever 12b of the pusher element 11 which are hinged respectively to the front end and back end of the handle grip 6a of the gun 6. When pressed, the command lever 12a, sliding on the activating lever 12b, contrasts a compression spring 13.

In the second embodiment, illustrated in FIG. 2, the activating means 12 are constituted by a single command lever 12 hinged to the front end of the handle grip 6a, while in the embodiment of FIG. 3 the activating means 12a are also constituted by a single command lever 12a, but hinged to the back end of the handle grip 6a.

The internal cavity 3 of the main body 2 exhibits, upstream of the annular seating 10, a containment chamber 3a of the ball obturator 9, which is of dimensions that permit lateral displacements of the obturator 9 with respect to the central axis 10a of the annular seating 10. The containment chamber 3a is anteriorly delimited by the annular seating 10 and posteriorly delimited (in an opposite position to the seating 10) by a limiter ring 14 which limits the longitudinal displacement of the obturator 9 when distancing from the annular seating 10.

The pusher element 11, constituted by a cylindrical pivot, is oriented in such a way that the push it exerts on the ball obturator 9 causes the latter to displace in a transversal direction to the central axis 10a of the annular seating 10.

The pusher element 11 exhibits a longitudinal axis 1 la which is perpendicular to the central axis 10a of the annular seating 10 and is internally slidable in a bushing 15 laterally coupled to the main body 2. The pusher element 11 is also slidable in a ring seal 16 arranged in proximity of the bushing 15 towards the inside of the main body 2.

The lateral arrangement of the pusher element 11 enables the inlet opening 4 and the outlet opening 5 to be aligned on the same longitudinal axis 11a, which coincides with the central axis 10a of the annular seating 10, as well as with the flow of the fluid.

In order to guarantee a partial detachment of the obturator 9 from the seating 10, advantageously the longitudinal axis 11a of the pusher element 11 does not pass through the centre of the obturator 9 when settled against the annular seating 10; rather it is eccentrically arranged to the side of the annular seating 10. In other words, the front end 11b of the pusher element 11 arranged towards the inside of the main body 2 is in contact with a surface zone of the ball obturator 9 comprised between a diametral section plane thereof which is perpendicular to the central axis 10a of the seating 10 and the seating 10 itself, so that the push exerted by the pusher element 11 has a component which is surely aimed distally from the annular seating 10.

The intercept valve, described above prevalently structurally, operates as follows.

In the closed position the spherical obturator 9 is pressed against the annular seating 10 by the hydrostatic force 17 of the fluid, as indicated in FIGS. 6, 7, 8 and 9.

In this position the edge of the annular seating 10 balances the hydrostatic force 17 with the constraining ratio 18 and 19, the value of which is sufficient to close the triangle of the opening forces (see FIGS. 6 and 8). From a comparison between FIGS. 6 and 8 it can be seen how, by increasing the diameter of the ball obturator 9, with a same hydrostatic force 17 the constraining reactions 18 and 19 reduce the angle formed by the vector of the hydrostatic force 17 with the central axis 10a and, consequently, are of lower intensity.

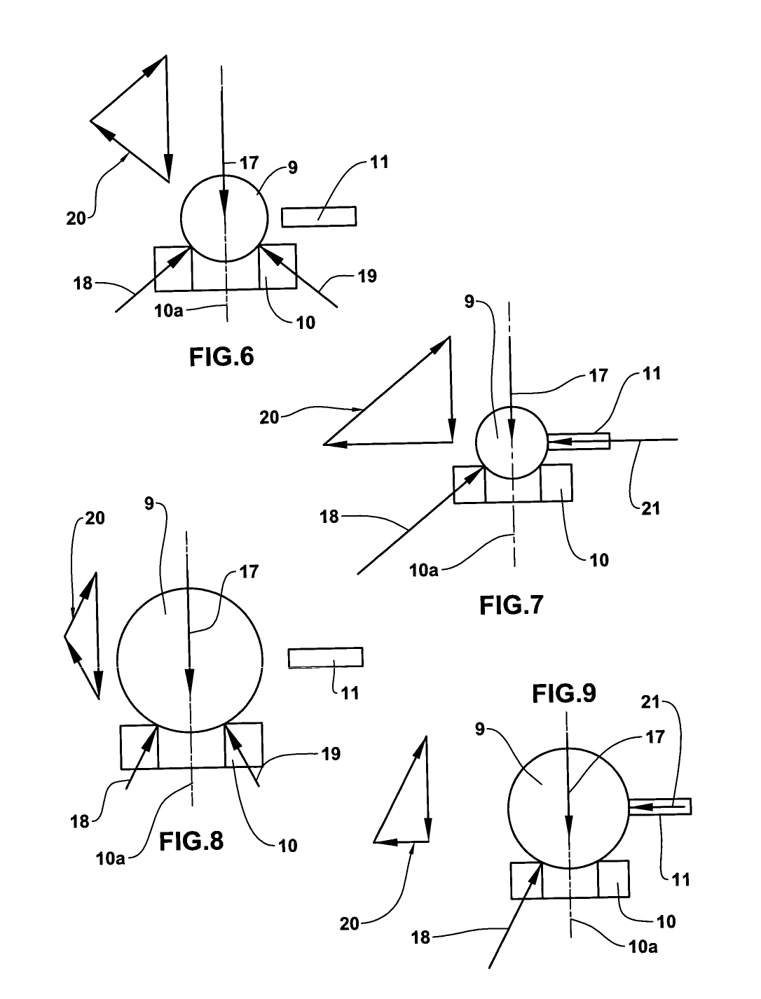

As soon as the pusher element 11 is pressed against the obturator 9, realizing a thrust force 21, the annular seating 10 is cleared of the part in which the pusher element 11 intervenes and there remains only the opposite constraining reaction 18, of a greater entity than the preceding situation of equilibrium (see FIGS. 7 and 9).

Note that, in order to detach the obturator 9 from the annular seating 10, the thrust force 21 must overcome the constraining reaction 18 component which is perpendicular to the central axis 10a.

A comparison between FIGS. 7 and 9 show how, as the diameter of the obturator 9 increases, the component of the constraining reaction 18 diminishes considerably and therefore so does the thrust 21 exerted by the pusher element 11, to a considerable extent. The advancing of the pusher element 11 determines the lateral displacement of the obturator 9 from the annular seating 10 and thus its partial detachment therefrom (see FIG. 5). When the pressure of the means for activating 12 on the pusher element 11 ceases, the pusher element 11 and the ball obturator 9 return into the initial position thanks to the thrust of the pressurised fluid. Also, the means for activating 12 when released return into the initial position both by effect of the return of the pusher element 11 and the compression spring 13 (if present) acting thereon.

The invention offers considerable advantages.

Firstly, the force needed for commuting the valve into the open position is considerable reduced with respect to the prior art, especially by using quite large ball obturators. Consequently the means for activating require a manoeuvring force of smaller entity and are less stressed.

Further, the lateral positioning of the pusher element 11 with respect to the annular seating of the ball obturator enables construction of a main body 2 for the valve with coaxial inlet and outlet, meaning a simple and economical construction having a high hydraulic performance.

The conformation of the above-described valve means it can be located at the posterior end of the handle grip of the spray gun and therefore permits use of especially ergonomic means for activating, and a comfortable location of the supply tube upstream of the valve.

Finally, the intercept valve of the invention does not require a spring acting on the ball obturator since the obturator displaces laterally in proximity of the annular seating (see FIG. 5), and the opposing hydraulic resistance is sufficient to return the ball into the seating. Therefore the pusher element has only to overcome the hydrostatic force of the pressurised fluid and no flow alterations occur due to the presence of a spring.

1. (canceled)

2. The spray gun of claim 7, wherein the ball obturator is spherical.

3. (canceled)

4. (canceled)

5. The spray gun of claim 7, wherein the containment chamber of the ball obturator comprises, in an opposite position to the annular seating, a limiter ring for limiting a distancing displacement of the ball obturator from the annular seating when the valve is in the open position.

6. The spray gun of claim 7, wherein the pusher element is a cylindrical pivot which is slidable internally of a bushing coupled laterally to the main body and internally of a ring seal arranged in proximity of the bushing.

7. A spray gun for water cleaner apparatus, comprising an intercept valve comprising: a main body exhibiting an internal cavity presenting an inlet opening and an outlet opening, the inlet opening being attached to a tube disposed upstream the valve and the outlet opening being attached to a tube disposed downstream the valve, upstream and downstream tube forming a conduit for a fluid;
a ball obturator and an annular seating arranged in the internal cavity, the ball obturator resting against the annular seating when the valve is in a closed position, the ball obturator being pushed against the annular seating by at least a pressurised fluid in the valve, the annular seating exhibiting a central longitudinal axis defining a flow direction of the pressurised fluid through the annular seating;
a pusher element controlled by means for activating, the pusher element exerting on the ball obturator a thrust able at least partially to detach the ball obturator from the annular seating, to change the intercept valve into an open position;
the internal cavity of the main body exhibits, upstream the annular seating, a containment chamber for the ball obturator, the containment chamber enables at least lateral displacements of the ball obturator with respect to the flow direction of the fluid, the pusher element being transversally oriented to the flow direction of the fluid and the thrust exerted on the ball obturator moving the ball obturator in a direction transversal to a central axis of the annular seating;
wherein the pusher element is arranged in contact with a surface zone of the ball obturator comprised between a diametrically intersecting plane of the ball obturator, perpendicular to the central axis of the annular seating, and the annular seating, the thrust exerted by the pusher element distancing the pusher element from the annular seating; and
wherein the inlet opening and the outlet opening of the main body are aligned on an axis which coincides with the central axis of the annular seating.

8. (canceled)

9. (canceled)

10. (canceled)

11. (canceled)

12. (canceled)
